(19) United States
(12) Patent Application Publication
(10) Pub. No.: US 2024/0427052 A1
(43) Pub. Date: Dec. 26, 2024

(54) DETECTING SUBSURFACE RESERVOIRS OF HYDROGEN IN GEOLOGICAL ROCK FORMATIONS

(71) Applicant: SAUDI ARABIAN OIL COMPANY, Dhahran (SA)

(72) Inventors: Markus ALBERTZ, The Woodlands, TX (US); Rajesh GOTETI, Katy, TX (US)

(73) Assignee: SAUDI ARABIAN OIL COMPANY, Dhahran (SA)

(21) Appl. No.: 18/341,571

(22) Filed: Jun. 26, 2023

(51) Int. Cl. G01V 9/00; G01V 3/38; G01V 99/00

(52) U.S. Cl. CPC G01V 9/007; G01V 3/38; G01V 20/00

(57) ABSTRACT

The present disclosure relates to systems and/or methods for predicting the location of subsurface reservoirs of natural hydrogen. One or more embodiments described herein include a system that can comprise a memory to store computer executable instructions. The system can also comprise one or more processors, operatively coupled to the memory, that execute the computer executable instructions to implement a hydrogen exploration controller configured to generate a plurality of maps characterizing a geographical region. The respective maps from the plurality of maps can delineate a location of respective geological features within the geographical region that are associated with a presence of a subsurface reservoir of natural hydrogen. Additionally the hydrogen exploration controller can be further configured to identify an area in the geographical region that comprises a convergence of two or more of the respective geological features based on the plurality of maps.

### FIELD OF THE DISCLOSURE

The present disclosure relates generally to systems and/or methods for the exploration of natural hydrogen reservoirs in subsurface geological formations and, more particularly, to exploration techniques that utilize aerial imaging, geographic information systems, electromagnetic surveys, and/or reflection seismology surveys to detect geographic areas characterized by a convergence of multiple geological features associated with the presence of a subsurface natural hydrogen reservoir.

### BACKGROUND OF THE DISCLOSURE

One way to reduce carbon dioxide emissions is to transition, at least partially, from hydrocarbon fuels to hydrogen fuels, which burns emission-free. For instance, hydrogen can decarbonize multiple sectors where achieving meaningful emissions reduction is difficult, such as long-haul transport, chemical manufacturing, and steel production. There is anticipation that hydrogen demand will increase from zero to significant proportions in nearly a variety of industries. However, because fossil fuels (e.g., particularly natural gas) are the primary feedstock for hydrogen production, there are also significant emissions associated with producing hydrogen from fossil fuels. Yet, hydrogen is the most common molecule in the universe and it occurs naturally in geological formations. Producing hydrogen directly from natural deposits presents an opportunity for further reducing emissions. Naturally occurring hydrogen (e.g., also referred to as geologic, native, white, or gold hydrogen), referred to herein as “natural hydrogen,” is likely to play a major role in establishing a hydrogen economy.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system is provided. The system can comprise a memory to store computer executable instructions. The system can also comprise one or more processors, operatively coupled to the memory, that execute the computer executable instructions to implement a hydrogen exploration controller configured to generate a plurality of maps characterizing a geographical region. The respective maps from the plurality of maps can delineate a location of respective geological features within the geographical region that are associated with a presence of a subsurface reservoir of natural hydrogen. Additionally the hydrogen exploration controller can be further configured to identify an area in the geographical region that comprises a convergence of two or more of the respective geological features based on the plurality of maps.

In another embodiment, a method is provided. The method can comprise generating a plurality of maps characterizing a geographical region. The respective maps from the plurality of maps delineate a location of respective geological features within the geographical region that are associated with a presence of a subsurface reservoir of natural hydrogen. The method can also comprise identifying an area in the geographical region that comprises a convergence of two or more of the respective geological features based on the plurality of maps.

In a further embodiment, computer program product for predicting a location of a subsurface reservoir of natural hydrogen is provided. The computer program product can comprise a computer readable storage medium having computer executable instructions embodied therewith. The computer executable instructions can be executable by the one or more processors to generate a plurality of maps characterizing a geographical region. The respective maps from the plurality of maps delineate a location of respective geological features within the geographical region that are associated with a presence of the subsurface reservoir of natural hydrogen. Additionally, the computer executable instructions can be executable by the one or more processors to identify an area in the geographical region that comprises a convergence of two or more of the respective geological features based on the plurality of maps.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a non-limiting example system for detecting subsurface natural hydrogen reservoirs utilizing data collected from aerial imaging, geographic information systems, electromagnetic surveys, and/or reflection seismology surveys in accordance with one or more embodiments described herein.

FIG. 2 is a diagram of a non-limiting example hydrogen exploration controller that can generate one or more maps of a geographical region, where the maps can delineate the location of subsurface geological features associated with natural hydrogen generation in accordance with one or more embodiments described herein.

FIG. 3 is a diagram of a non-limiting example hydrogen exploration controller that can generate one or more maps of a geographical region, where the maps can delineate the location of areas accessible to drilling campaigns in accordance with one or more embodiments described herein.

FIG. 4 is a diagram of a non-limiting example hydrogen exploration controller that can generate one or more maps of a geographical region, where the maps can delineate the location subsurface natural hydrogen based on an electromagnetic survey performed in the region in accordance with one or more embodiments described herein.

FIG. 5 is a diagram of a non-limiting example, hydrogen exploration controller that can generate one or more maps of a geographical region, where the maps can delineate the location of surface, or near surface, level hydrogen seepages in accordance with one or more embodiments described herein.

FIG. 6 is a diagram of a non-limiting example hydrogen exploration controller that can generate one or more maps of a geographical region, where the maps can delineate the subsurface geological configuration of the region based on reflection seismology surveys in accordance with one or more embodiments described herein.

FIG. 7 is a diagram of a non-limiting example hydrogen exploration controller that can generate one or more maps of a geographical region, where the maps can delineate the location of areas comprising subsurface geological properties associated with a high propensity for natural hydrogen generation, migration, and/or accumulation in accordance with one or more embodiments described herein.

FIG. 8 is a diagram of a non-limiting example hydrogen exploration controller that can generate one or more maps of geographical region, where the maps can delineate the location of areas comprising a convergence of surface and/or subsurface geological features associated with the generation, migration, and/or accumulation of natural hydrogen in accordance with one or more embodiments described herein.

FIG. 9 is a flow diagram of a non-limiting example method that can be implemented to detect subsurface natural hydrogen reservoirs utilizing data collected from aerial imaging, geographic information systems, electromagnetic surveys, and/or reflection seismology surveys in accordance with one or more embodiments described herein.

FIG. 10 illustrates a block diagram of non-limiting example computer environment that can be implemented within one or more systems described herein.

### DETAILED DESCRIPTION

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Several processes are widely believed to produce natural hydrogen, such as: serpentinization, and radiolysis. Serpentinization is a metamorphic reaction in which ultramafic rocks are oxidized by water thus forming serpentine and hydrogen. Ultramafic rocks are mainly found in the Earth's mantle and are typically peridotite, which mainly consists of olivine minerals. Laboratory experiments confirm that the following serpentinization reactions produce hydrogen:

3FeO (in silicates)+H₂O→Fe₃O₄ (magnetite)+H₂(aqueous) 3Fe₂Sio₄+2H₂O→3Sio₂+2Fe₃O₄+2H₂(aqueous)

In addition, radiolysis is a process that produces hydrogen through dissociation of water during radioactive decay of uranium (U), thorium (Th), and potassium (K). The dissociation of water occurs by the release of α, β, and/or γ particles during radiogenic decay. Unlike serpentinization, which requires ultramafic rocks to be present, radiolysis only requires water and radioactive elements.

Natural hydrogen occurs as a free gas (e.g., dissolved gas in groundwater) and as inclusions in rocks. Finding natural hydrogen as inclusions in rocks presents numerous technical and environmental challenges, such as large energy requirements for mining operations and environmental impact of crushing rock to release hydrogen gas. While hydrogen sometimes co-exists with methane and other gases in the Earth's subsurface, areas where significant hydrogen deposits may occur are typically not examined by the petroleum industry. In particular, hydrogen occurs in substantial quantities in four geologic settings: (1) ophiolites associated with obduction of mantle rocks, (2) serpentinized mantle in failed rift (aulacogen) settings, (3) crystalline basement in cratonic areas, and (4) mid-ocean ridges.

Embodiments in accordance with the present disclosure generally relate to systems and/or methods for natural hydrogen exploration in onshore geologic formations. Various embodiments described herein can include consecutive stages of exploration and analysis that progress from a large, regional scale to a smaller, prospect scale to increase the confidence of locating an economically viable occurrence of natural hydrogen. For example, one or more stages of natural hydrogen exploration described herein can generate maps delineating the location of respective types of geological features associated with the occurrence of a subsurface hydrogen reservoir, where the maps can be overlaid upon each other to identify exploration areas of interest comprising a plethora of said geological features. Further, areas identified by the map analysis can be targeted for further economic analysis and/or exploratory drilling. In various embodiments, the systems and/or methodologies described herein can further be adapted to identify areas of interest for maximum hydrogen capture from active mid ocean ridges and/or rifting continents, thereby being applicable to both onshore and offshore hydrogen exploration.

Moreover, various embodiments described herein can constitute one or more technical improvements over conventional hydrogen reservoir exploration techniques by employing aerial imaging, electromagnetic surveying, reflection seismology, and petrophysics analyses to identify a convergence of geological features associated with natural hydrogen generation, migration, and/or accumulation. Additionally, one or more embodiments described herein can have a practical application by identifying areas for hydrogen gas exploratory drilling campaigns. For example, one or more embodiments described herein can control aerial imaging devices, reflection seismology systems, geographic information systems, and/or hydrogen detection devices to identify surface characteristics, and subsurface geological configurations, associated with natural hydrogen reservoirs.

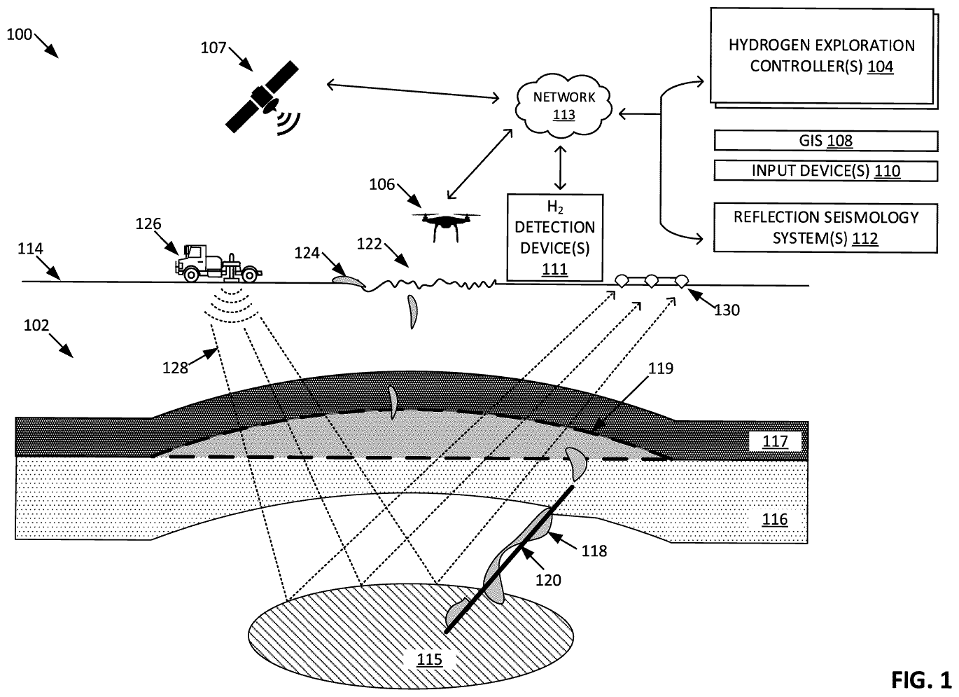

FIG. 1 illustrates a non-limiting example system 100 that can implemented to detect subsurface reservoirs 102 of natural hydrogen in accordance with one or more embodiments described herein. In various embodiments described herein, the subsurface reservoirs 102 can include static accumulations of hydrogen accessible in porous rock and/or trapped hydrogen accumulations leaking from a reservoir, where the accumulation rate is greater than the leakage rate. In some embodiments described herein, the subsurface reservoirs 102 can include active accumulations of hydrogen, where the accumulation rate of hydrogen within the rock exceeds the leakage rate of hydrogen from the porous rock despite the lack of a scaling rock layer (e.g., despite the absence of an anticlinal trap). In one or more embodiments, one or more hydrogen exploration controllers 104 (e.g., a server, a desktop computer, a laptop, a hand-held computer, a programmable apparatus, a minicomputer, a mainframe computer, an Internet of things (“IoT”) device, and/or the like) can be operably coupled to (e.g., communicate with) one or more aerial drones 106, satellites 107, geographic information systems (“GIS”) 108, input devices 110, hydrogen detection devices 111, and/or reflection seismology systems 112 via one or more networks 113.

The one or more networks 113 can comprise one or more wired and/or wireless networks, including, but not limited to: a cellular network, a wide area network (“WAN”), a local area network (“LAN”), a combination thereof, and/or the like. One or more wireless technologies that can be comprised within the one or more networks 113 can include, but are not limited to: wireless fidelity (“Wi-Fi”), a WiMAX network, a wireless LAN (“WLAN”) network, BLUETOOTH® technology, a combination thereof, and/or the like. For instance, the one or more networks 113 can include the Internet and/or the IoT. In various embodiments, the one or more networks 113 can comprise one or more transmission lines (e.g., copper, optical, or wireless transmission lines), routers, gateway computers, and/or servers. Further, the one or more hydrogen exploration devices 104 can comprise one or more network adapters and/or interfaces (not shown) to facilitate communications via the one or more networks 113.

FIG. 1 depicts an example subsurface reservoir 102 that can be detected by the system 100. As shown in FIG. 1, the subsurface reservoir 102 is positioned below the surface 114 of an onshore environment. The subsurface reservoir 102 can include a source rock 115, a reservoir rock 116, and/or a seal rock 117. For instance, natural hydrogen 118 is generated in the source rock 115 via serpentinization or radiolysis. In the illustrated example, the natural hydrogen 118 then migrates along a fault 120 in the Earth's crust, whereupon the natural hydrogen 118 can accumulate in an anticlinal trap 119 under the seal rock 116. The seal rock 117 can be impermeable rock that inhibits further migration of the natural hydrogen 118. However, a portion of the natural hydrogen 118 can escape through the seal rock 117 and can continue migrating towards the surface 114, where it manifests itself as a fairy circle 122 and/or a hydrogen seepage 124.

In various embodiments, the system 100 can utilize the hydrogen exploration controllers 104 to detect the presence of subsurface reservoirs 102 of natural hydrogen 118. For example, the hydrogen exploration controllers 104 can collect aerial imaging data from one or more planes and/or satellites 107 regarding the surface 114 of a geographical region. In another example, the hydrogen exploration controllers 104 can collect data regarding one or more electromagnetic surveys of the region conducted by the one or more aerial drones 106. In a further example, the hydrogen exploration controllers 104 can collect data from the GIS 108 regarding known geological formations in the region. In a still further example, the hydrogen exploration controllers 104 can collect data from the one or more input devices regarding, for example: land use restrictions; geophysical data harvested from offset wells and/or outcrops in the region; and/or pre-defined threshold values for one or more analyses described herein. In another example, the hydrogen exploration controllers 104 can collect geochemistry data from one or more hydrogen detection devices 111 positioned near fairy circles 122 and/or hydrogen seepages 124. In yet another example, the hydrogen exploration controllers 104 can collect seismology data regarding one or more reflection seismology surveys conducted by the reflection seismology system 112 in the region. For instance, the reflection seismology systems can utilize one or more seismic energy sources 126 (e.g., such as a vibration truck) to propagate seismic energy waves 128 into the subsurface, which are reflected from geological formations and captured by one or more seismic energy receivers 130 (e.g., such as an array of geophones) for recordation and interpretation by the reflection seismology systems 112.

Further, the one or more hydrogen exploration controllers 104 can generate a plurality of maps of the geographic regions, where each map can delineate the location of respective types of geographical features characterized by the data collected by the hydrogen 5 exploration controllers 104. In various embodiments, the one or more hydrogen exploration controllers 104 can utilize the maps to identify areas of interest for exploratory drilling campaigns and/or facilitate economic viability assessments.

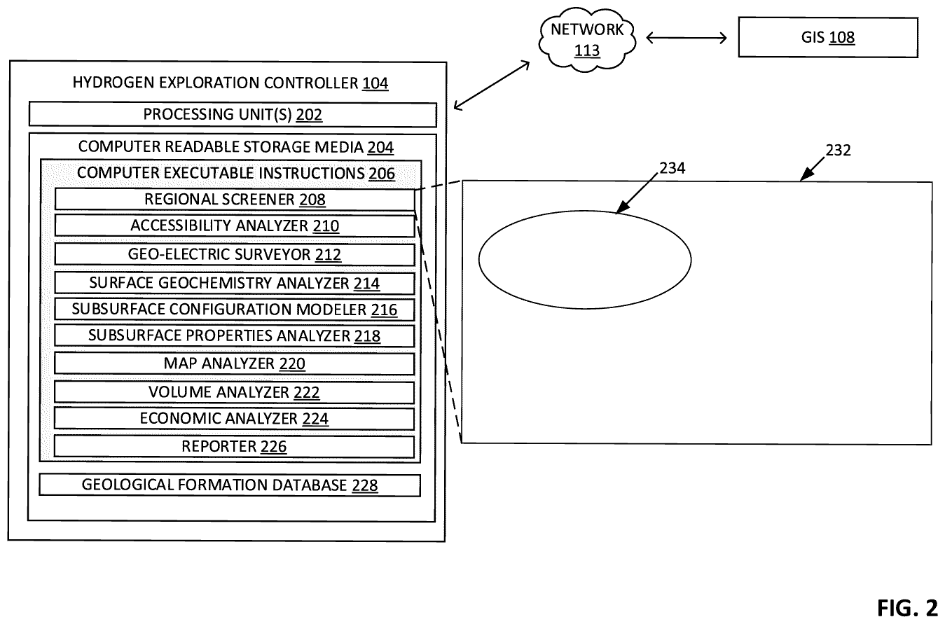

As shown in FIG. 2, the one or more hydrogen exploration controllers 104 can comprise one or more processing units 202 and/or computer readable storage media 204. In various embodiments, the computer readable storage media 204 can store one or more computer executable instructions 206 that can be executed by the one or more processing units 202 to perform one or more defined functions. In various embodiments, a regional screener 208, accessibility analyzer 210, geo-electric surveyor 212, surface geochemistry analyzer 214, subsurface configuration modeler 216, subsurface properties analyzer 218, map analyzer 220, volume analyzer 222, economic analyzer 224, and/or reporter 226 can be computer executable instructions 206 and/or can be hardware components operably coupled to the one or more processing units 202. For instance, in some embodiments, the one or more processing units 202 can execute the regional screener 208, accessibility analyzer 210, geo-electric surveyor 212, surface geochemistry analyzer 214, subsurface configuration modeler 216, subsurface properties analyzer 218, map analyzer 220, volume analyzer 222, economic analyzer 224, and/or reporter 226 to perform various functions described herein (e.g., natural hydrogen 118 detection).

The one or more processing units 202 can comprise any commercially available processor. For example, the one or more processing units 202 can be a general purpose processor, an application-specific system processor (“ASSIP”), an application-specific instruction set processor (“ASIPs”), or a multiprocessor. For instance, the one or more processing units 202 can comprise a microcontroller, microprocessor, a central processing unit, and/or an embedded processor. In one or more embodiments, the one or more processing units 202 can include electronic circuitry, such as: programmable logic circuitry, field-programmable gate arrays (“FPGA”), programmable logic arrays (“PLA”), an integrated circuit (“IC”), and/or the like.

The one or more computer readable storage media 204 can include, but are not limited to: an electronic storage device, a magnetic storage device, an optical storage device, an electromagnetic storage device, a semiconductor storage device, a combination thereof, and/or the like. For example, the one or more computer readable storage media 204 can comprise: a portable computer diskette, a hard disk, a random access memory (“RAM”) unit, a read-only memory (“ROM”) unit, an erasable programmable read-only memory (“EPROM”) unit, a CD-ROM, a DVD, Blu-ray disc, a memory stick, a combination thereof, and/or the like. The computer readable storage media 204 can employ transitory or non-transitory signals. In one or more embodiments, the computer readable storage media 204 can be tangible and/or non-transitory. In various embodiments, the one or more computer readable storage media 204 can store the one or more computer executable instructions 206 and/or one or more other software applications, such as: a basic input/output system (“BIOS”), an operating system, program modules, executable packages of software, and/or the like.

The one or more computer executable instructions 206 can be program instructions for carrying out one or more operations described herein. For example, the one or more computer executable instructions 206 can be, but are not limited to: assembler instructions, instruction-set architecture (“ISA”) instructions, machine instructions, machine dependent instructions, microcode, firmware instructions, state-setting data, configuration data, source code, object code, a combination thereof, and/or the like. For instance, the one or more computer executable instructions 206 can be written in one or more procedural programming languages. Although FIG. 2 depicts the computer executable instructions 206 stored on computer readable storage media 204, the architecture of the system 100 is not so limited. For example, the one or more computer executable instructions 206 can be embedded in the one or more processing units 202.

In various embodiments, the regional screener 208 can utilize the GIS 108 to screen onshore regions of the Earth for geological formations associated with natural hydrogen 118 accumulation. For example, the regional screener 208 can identify areas within one or more onshore regions that comprise geological formations, such as: ophiolites, aulacogens, and/or cratons. The GIS 108 can be an additional computer executable instruction 206 or can be external to, and operably coupled with, the hydrogen exploration controller 104 (e.g., via the one or more networks 108, as shown in FIG. 2). For instance, the GIS 108 can be designed to store, retrieve, manage, display, conduct calculations, and/or analyze various types of geographic and spatial data (e.g., georeferenced to specific exploration areas). In various embodiments, the GIS 108 can be desktop-based, web-based, cloud-based, and/or local network-based. Further, the GIS 108 can characterize defined values (e.g., discrete, spatially, continuous, and/or varying inputs) via one or more generated maps (e.g., two-dimensional or three-dimensional volumes of property variations that can be used to display spatial attributes of the geospatial data). In various embodiments described herein, the hydrogen exploration controller 104 can utilize the functionality of the GIS 108 to generate one or more maps described herein. For instance, one or more of the computer executable instructions 206 described herein can utilize the GIS 108 to generate respective maps characterizing the outputs and/or determinations made by the computer executable instructions 206.

In one or more embodiments, a geological formation database 228 can be stored in the computer readable storage media 204, where the geological formation database 228 can be generated, updated, and/or maintained by the GIS 108. The geological formation database 228 can include vector data, grid data, sensor data, imaging data, and/or the like that characterize geological configurations of surface and/or subsurface regions of Earth. In various embodiments, the one or more geological formation databases 228 can be populated with data generated and/or gathered via other geological exploration endeavors (e.g., data collected through the exploration for petroleum reservoirs) documented by the GIS 108. The regional screener 208 can reference the geological formation database 228 to identify one or more areas within a given geological region that include geological formations of interest, such as ophiolites, aulacogens, and/or cratons.

As shown in FIG. 2, the regional screener 208 can generate a first map 232 of the region of interest. Additionally, the first map 232 can delineate one or more areas of the region that include the targeted geological formations based on the GIS 108 and/or geological formation database 228. In one or more embodiments, the regional screener 208 can identify one or more targeted geological formations (e.g., ophiolites, aulacogens, and/or cratons) defined in the geological formation database 228 as inputs to the GIS 108 to generate the first map 232. FIG. 2 depicts an example first map 232 that can be generated by the regional screener 208 (e.g., in conjunction with the GIS 108) that includes an ellipse 234 delineating the location of ophiolites, aulacogens, and/or cratons based on the data included in the geological formation database 228 and/or provided by the GIS 108.

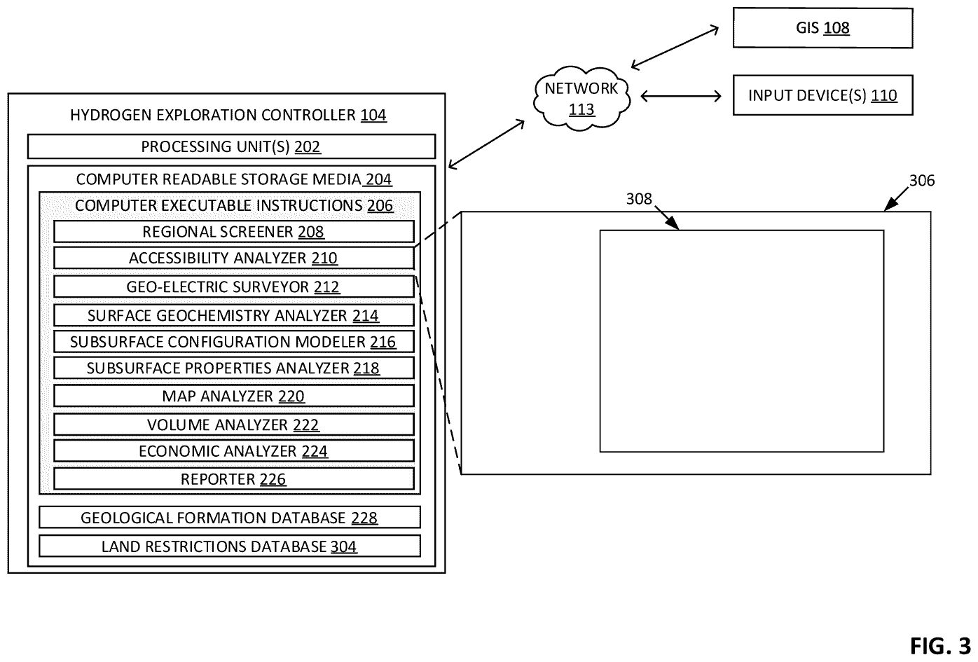

FIG. 3 illustrates a diagram of the non-limiting example hydrogen exploration controller 104 operably coupled to the one or more input devices 110, which can be employed to populate one or more land restriction databases 304 to evaluate accessibility within the regions in accordance with one or more embodiments described herein. In various embodiments, the accessibility analyzer 210 can evaluate whether the evaluated regions include areas that are accessible from geographic and/or land use perspectives.

The accessibility analyzer 210 can evaluate the accessibility of the regions based on the geological formation database 228 and/or the land restrictions database 304. For instance, the geological formation database 228 can include data characterizing the location of civil infrastructure (e.g., roads, bridges, ports, municipalities, and/or the like) along with a topological analysis (e.g., delineating elevation, rivers, lakes, mountains, ravines, and/or the like) of the region. Also, the land restriction database 304 can include data characterizing ownership rights, casements, legal regulations (e.g., regarding zoning, permits, and/or environmental concerns), political climate (e.g., that status of possible military conflicts in the region), a combination thereof, and/or the like. In one or more embodiments, the accessibility analyzer 210 can identify areas of the region as inaccessible for natural hydrogen 118 retrieval efforts due to, for example: mountainous terrain, remote locations (e.g., distance from the nearest metropolitan area, road, port, and/or other civil infrastructure), densely populated urban areas, zoning restrictions, drilling regulations, public park designations, a combination thereof, and/or the like.

For example, the accessibility analyzer 210 can identify areas in which drilling wells is impermissible due to statutory restrictions (e.g., zoning, permit, and/or environmental regulations) as inaccessible areas. In another example, the accessibility analyzer 210 can identify areas that cannot support drilling equipment (e.g., due to uneven and/or unstable ground) or cannot be reached by drilling or surveying equipment (e.g., due to the areas remote nature, lack of nearby infrastructure, and/or presence of inhibiting natural features, such as unbridged rivers) as inaccessible areas.

In accordance with one or more embodiments described herein, the accessibility of an area can be determined (e.g., by the accessibility analyzer 210) with respect to the exploration phase, development phase, and/or production phase of a hydrogen well. With regards to the exploration phase, accessibility can characterize an ability to conduct one or more of the following operations in an area: conducting surface seep surveys, seismic surveys, installation of permanent equipment for monitory and conducting field-based studies, transporting drilling equipment for exploratory drilling, a combination thereof, and/or the like. With regards to the development phase, accessibility can characterize an area's proximity to existing facilities, roads, infrastructure, defined supply and/or distribution networks, a combination thereof, and/or the like. With regards to the production phase, accessibility can characterize an ability to construct surface-level facilities to collect and distribute natural resources from a successful well.

As shown in FIG. 3, the accessibility analyzer 210 can generate a second map 306 of the given region. In one or more embodiments, the accessibility analyzer 210 can identify one or more accessible areas as inputs to the GIS 108 to generate the second map 306. Additionally, the second map 306 can delineate one or more areas of the region that are accessible for natural hydrogen 118 retrieval based on the geological formation database 228 and/or land restrictions database 304. For instance, the example second map 306 shown in FIG. 3 includes a rectangular dotted line 308 delineating the location of accessible areas based on the data included in the geological formation database 228 and/or land restrictions database 304.

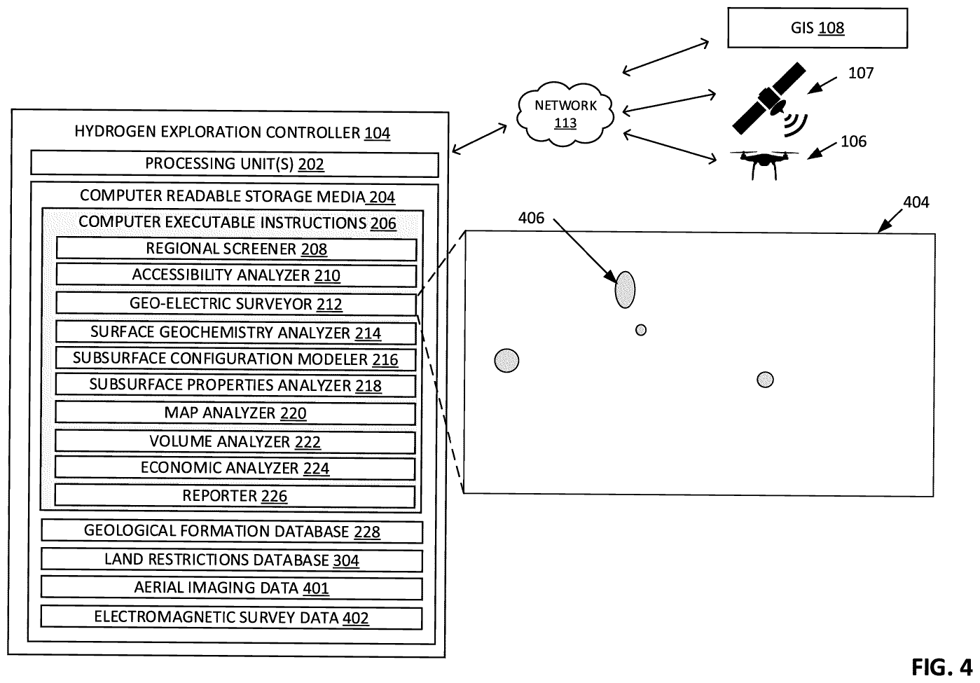

FIG. 4 illustrates a diagram of the non-limiting example hydrogen exploration controller 104 operably coupled to one or more satellites 107 and/or aerial drones 106, which can be employed to conduct one or more drone-based electromagnetic surveys in accordance with one or more embodiments described herein. In various embodiments, geo-electric surveyor 212 can control one or more geophysical electromagnetic surveys conducted within the given region to identify surface and/or subsurface electromagnetic anomalies that can be associated with the presence of natural hydrogen 118.

In one or more embodiments, the geo-electric surveyor 212 can analyze aerial imaging data 401 of the region to detect anomalies at the surface 114 of the region. The aerial imaging data 401 can be captured by the one or more satellites 107 (e.g., as shown in FIG. 4), airplanes, and/or drones 106 flying over the surface 114. Surface anomalies detected by the geo-electric surveyor 212 can include fairy circles 122, which can be depressions in the surface 114 of the Earth that form in the soil when natural hydrogen 118 emanates from a subsurface source (e.g., as exemplified in FIG. 1). For example, the geo-electric surveyor 212 can analyze diameter versus depth relations to distinguish captured fairy circles 122 from other circular surface 114 anomalies (e.g., such as karsts).

Further, the geo-electric surveyor 212 can control, and/or otherwise define the flight path for, the one or more aerial drones 106, which can be unmanned aerial vehicles (“UAVs”) such as vertical take-off and landing (“VTOL”) drones. The aerial drones 106 can be equipped with (e.g., can tow) electromagnetic surveying equipment, such as electromagnetic transmitters (e.g., comprising one or more loops of insulated metal wire) and/or receivers (e.g., one or more other loops of insulated metal wire and/or induction coils). For instance, the aerial drones 106 can be outfitted with a horizontal loop electromagnetic system, a coaxial vertical loop electromagnetic system, a vertical coplanar loop electromagnetic system, a combination thereof, and/or the like. The electromagnetic surveying system can comprise a first aerial drone 106, equipped with an electromagnetic transmitter, and a second aerial drone 106, equipped with an electromagnetic receiver (e.g., a 3-component receiver), flying in tandem (e.g., along the same surveying flight path or side-by-side, parallel flight paths); where a constant distance is maintained between the aerial drones 106.

In various embodiments, the geo-electric surveyor 212 can set the flight path of the one or more aerial drones 106 to fly over detected fairy circles 122, such that the equipped electromagnetic surveying equipment can map the geo-electrical properties of near-surface (e.g., from 0 to 100 meters) parts of the region. Changes in the measured electromagnetic field in an area can be caused by petrophysical properties (e.g., electrical conductivity, magnetic susceptibility, density, seismic P-wave velocities, and/or the like) of surface and/or subsurface materials. In one or more embodiments, electromagnetic survey data 402 collected by the one or more aerial drones 106 can be utilized by the geo-electric surveyor 212 to model (e.g., two dimensionally or three-dimensionally) lateral changes and/or depth variations of the subsurface geological configuration. In some embodiments, the geo-electric surveyor 212 can further interpret and/or process the electromagnetic survey data 402 to model subsurface electromagnetic anomalies. For instance, the geo-electric surveyor 212 can perform one or more noise reduction operations to the electromagnetic survey data 402.

In one or more embodiments, the geo-electric surveyor 212 can directly control the flight path of the one or more aerial drones 106 and collect, interpret, and/or process the electromagnetic survey data 402. Alternatively, the geo-electric surveyor 212 can define one or more areas of interest for the electromagnetic survey based on the aerial imaging analysis and share the areas of interest with one or more external surveying systems (e.g., via the one or more networks 113) that in turn conduct the electromagnetic survey and supply the electromagnetic survey data 402 to the hydrogen exploration controller 104. For instance, one or more external surveying systems (not shown) can control the flight path of the one or more aerial drones 106 based on coordinates provided by the geo-electric surveyor 212 to collect and/or process electromagnetic survey data 402 for further analysis by the geo-electric surveyor 212.

As shown in FIG. 4, the geo-electric surveyor 212 can generate a third map 404 of the region of interest. In one or more embodiments, the geo-electric surveyor 212 can identify one or more areas associated with electromagnetic anomalies as inputs to the GIS 108 to generate the third map 404. Additionally, the third map 404 can delineate one or more areas of the region that include anomalies included in the electromagnetic survey data 402 that can be associated with the presence of natural hydrogen 118 accumulation and/or migration. For instance, the example third map 404 shown in FIG. 4 includes grey-shaded areas 406 delineating the location of surface and/or subsurface anomalies in the electromagnetic survey data 402.

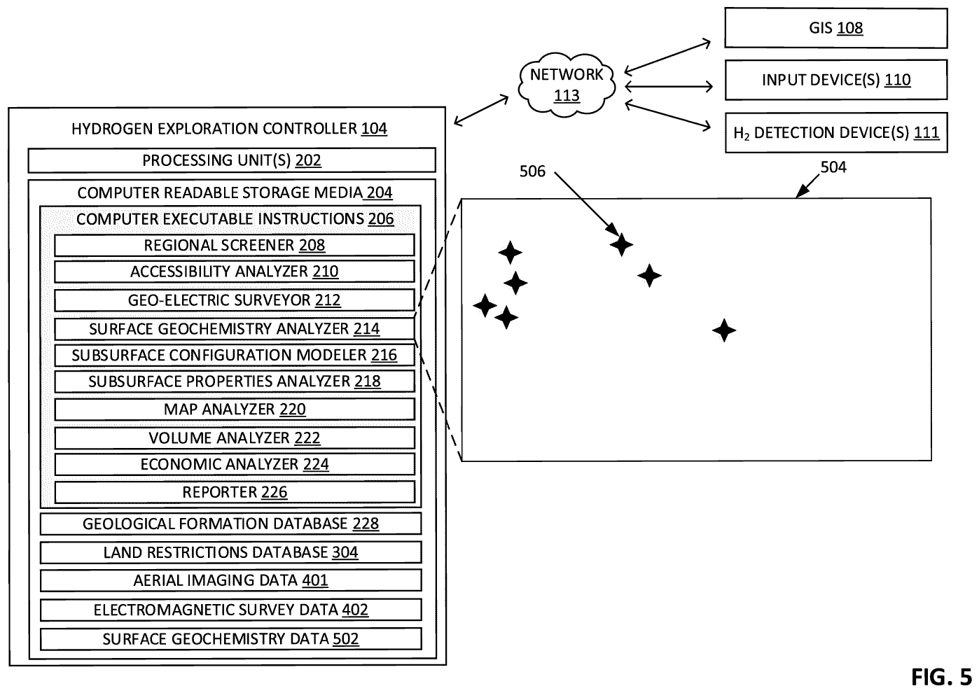

FIG. 5 illustrates a diagram of the non-limiting example hydrogen exploration controller 104 comprising the surface geochemistry analyzer 214, which can be configured to detect hydrogen seepages 124 in accordance with one or more embodiments described herein. In one or more embodiments, the surface geochemistry analyzer 214 can analyze surface geochemistry data 502 provided by the one or more input devices 302 and/or hydrogen detection devices 504 to detect hydrogen seepages 124.

For example, one or more seepage analyses and/or soil gas surveys can be conducted near detected fairy circles 122. As described above, the geo-electric surveyor 212 can identify fairy circles 122 from the aerial imaging data 401; further, the surface geochemistry analyzer 214 can share the location of the identified fairy circles 122 with one or more users employing the system 100 (e.g., the fairy circle 122 locations can be shared with one or more users via a user interface of the one or more input devices 302). Thereby, the one or more hydrogen detection devices 111 can be employed at the site of the fairy circles 122 to detect hydrogen within air and/or soil to identify hydrogen seepages 124. For example, the one or more hydrogen detection devices 111 can include one or more soil-gas analyzers, such as a portable gas analyzer coupled to a probe (e.g., an inox tube). The hydrogen detection devices 111 can collect surface geochemistry data 502, which can characterize, for example, the amount of hydrogen with an air or soil sample.

As shown in FIG. 5, the surface geochemistry analyzer 214 can generate a fourth map 504 of the region of interest. In one or more embodiments, the surface geochemistry analyzer 214 can identify areas of hydrogen seepages 124 as inputs to the GIS 108 to generate the fourth map 504. Additionally, the fourth map 504 can delineate one or more areas of the region that include hydrogen seepages 124 that can be associated with the presence of natural hydrogen 118 accumulation. For instance, the example fourth map 504 shown in FIG. 5 includes black stars 506 delineating the location of the hydrogen seepages 124 at the surface 114. In one or more embodiments, hydrogen seepages 124 can occur outside of areas associated with subsurface anomalies (e.g., such as the subsurface anomalies detected by the electromagnetic survey data 402), depending on the path utilized by the hydrogen to migrate to the surface (e.g., depending on the trajectory of one or more faults 120). Thus, the third map 404 can delineate the location of surface and/or subsurface anomalies, while the fourth map 504 can delineate the location of surface hydrogen seepages 124.

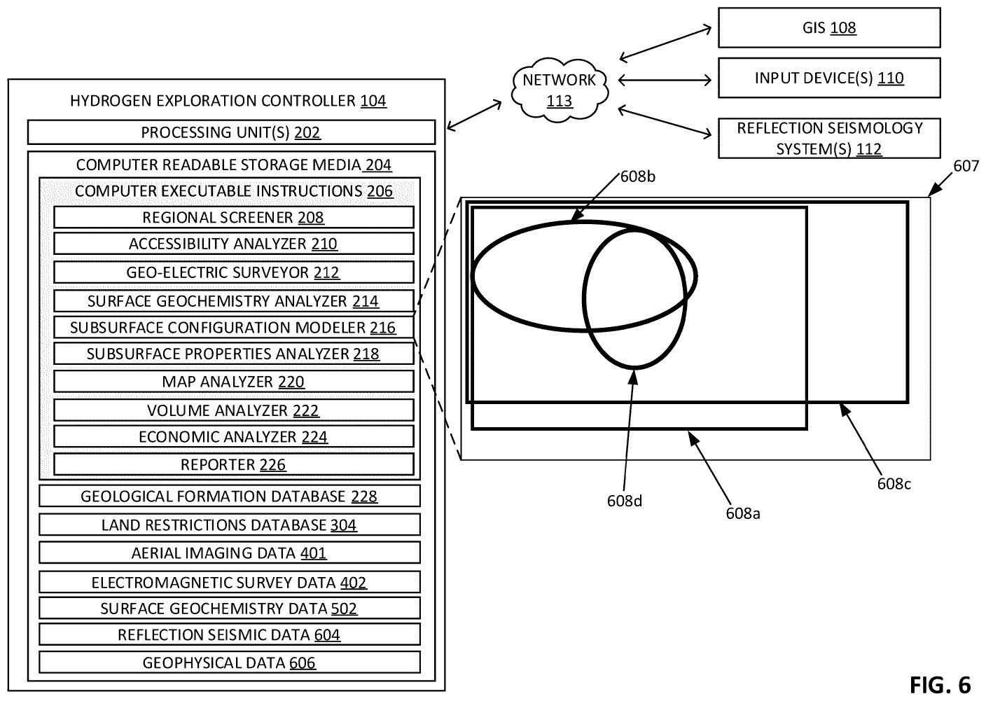

FIG. 6 illustrates a diagram of the non-limiting example hydrogen exploration controller 104 comprising the subsurface configuration modeler 216, which can be configured to characterize subsurface geological configurations within the one or more regions of interest in accordance with one or more embodiments described herein. In various embodiments, the one or more hydrogen exploration controllers 104 can be operably coupled to one or more reflection seismology systems 112 (e.g., via the one or more networks 113), which can provide reflection seismic data 604 to be analyzed by the subsurface configuration modeler 216.

In one or more embodiments, the reflection seismology systems 112 can be employed to generate reflection seismic data 604 (e.g., two-dimensional or three-dimensional modeling data) that can characterize the geometry of rock layers beneath the surface 114 of the one or more regions of interest. For example, the reflection seismology systems 112 can perform one or more reflection seismology surveys within the region to collect the reflection seismic data 604. For instance, one or more seismic wave sources 126 (e.g., including explosive and/or mechanical seismic sources) and receivers 130 (e.g., including geophones, recorders, and/or passband filters) can be positioned at the surface 114. The seismic wave sources 126 can project seismic waves 128 into the subsurface of the Earth, whereupon the seismic waves 128 can reflect from various subsurface geological formations and be detected by the seismic receivers 130 (e.g., as exemplified in FIG. 1).

For instance, the one or more reflection seismology systems 112 can include an array (e.g., a linear array) of seismographs and/or geophones utilized with an energy source (e.g., which provides a “shot” of seismic energy), where the refraction of seismic waves on geologic layers of rock and/or soil can be recorded to characterize subsurface geologic conditions and/or structures. The seismic waves 128 can exhibit differing velocities depending on the type of soil and/or rock encountered, and the seismic waves 128 can be refracted as they cross the boundary between differing geological formations. The reflection seismology surveys can map multiple horizons of seal rock 117, reservoir rock 116, and/or source rock 115 to detect one or more anticlinal traps 119. In one or more embodiments, the subsurface configuration modeler 216 can analyze the reflection seismic data 604 to identify concave portions of the reservoir rock 116 as potential anticlinal trap 119 locations (e.g., as exemplified in FIG. 1). Additionally, the subsurface configuration modeler 216 can analyze the reflection seismic data 604 to identify faults 120 extending between rock layers.

Additionally, the subsurface configuration modeler 216 can characterize the subsurface geological configuration of the region based on geophysical data 606 collected from one or more offset wells and/or outcrops in the region. For example, geophysical data 606 can be entered into the system 100 by one or more users via the GIS 108 software and/or the one or more input devices 110, where the geophysical data 606 can characterize known subsurface geological configurations in the region. For instance, petroleum exploration wells, deep research wells, and/or water wells can be exploited to constrain and/or validate seismic interpretations of rock layers by the subsurface configuration modeler 216. In another example, geophysical data 606 can be harvested from outcrops within the region and utilized by the subsurface configuration modeler 216 to project the geological configurations of the outcrop into the subsurface. In one or more embodiments, the subsurface configuration modeler 216 can map the geophysical data 606 to the subsurface geological geometries modeled by the reflection seismic data 604 to associate detected geological formations (e.g., detect rock layers) with the presence of source rock 115, reservoir rock 116, and/or seal rock 117. For instance, the known presence and/or depth of porous rocks (e.g., sandstone or carbonate) within the region, as defined by the geophysical data 606, can be correlated to geological formations modeled by the reflection seismic data 604; thereby, the presence of reservoir rock 116 can be determined by the subsurface configuration modeler 216. In another instance, the known presence and/or depth of impermeable, or semi-impermeable, rocks (e.g., shale or dolerites) within the region, as defined by the geophysical data 606, can be correlated to geological formations modeled by the reflection seismic data 604; thereby, the presence of seal rock 117 can be determined by the subsurface configuration modeler 216.

For example, the subsurface characterization determined by the subsurface configuration modeler 216 can include one or more of the following features. The geometry and/or architecture of subsurface rock layers can be characterized from the surface 114 down to the source rock 115. For instance, the geometry and/or architecture can be characterized by geophysical data such as: interpretations of the reflection seismic data 604, magnetic modeling, gravity modeling, and/or rock physics modeling. Also, the subsurface can be characterized via two-dimensional and/or three-dimensional geological property modeling (e.g., modeling the porosity, permeability, saturation of fluids, and/or rock mineralogy of a subsurface area). Further, the subsurface characterization can delineate the extent of source rocks 115, migration pathways (e.g., faults 120), reservoir rocks 116, and/or seal rocks 117. Moreover, the subsurface characterization can identify the geochemical, biological, and/or geomechanical state of the subsurface area to assess the impact on natural hydrogen that may be produced or stored by the subsurface reservoir 102. In one or more embodiments, the subsurface characterization can occur over a broad range of scales (e.g., on the scale of multiple square kilometers or the scale of single wellbore). Additionally, the subsurface characterization can include subsurface reservoir 102 testing and/or production forecasting given the subsurface geology. Moreover, the subsurface characterization can include geological, geophysical, and/or petrophysical properties of subsurface fluids.

As shown in FIG. 6, the subsurface configuration modeler 216 can generate a fifth map 607 of the region of interest. In one or more embodiments, the subsurface configuration modeler 216 can identify subsurface geological formations characterized by the reflection seismic data 604 as inputs to the GIS 108 to generate the fifth map 607. Additionally, the fifth map 607 can delineate the location of source rock 115, reservoir rock 116, seal rock 117, and/or anticlinal traps 119 within the region, based on the reflection seismic data 604 and/or geophysical data 606. For instance, the example fifth map 607 shown in FIG. 6 includes: a first bold line 608a delineating the location of source rock 115 within the region; a second bold line 608b delineating the location of reservoir rock 116 within the region; a third bold line 608c delineating the location of seal rock 117 within the region; and/or a fourth bold line 608d delineating the location of anticlinal traps 119 within the region.

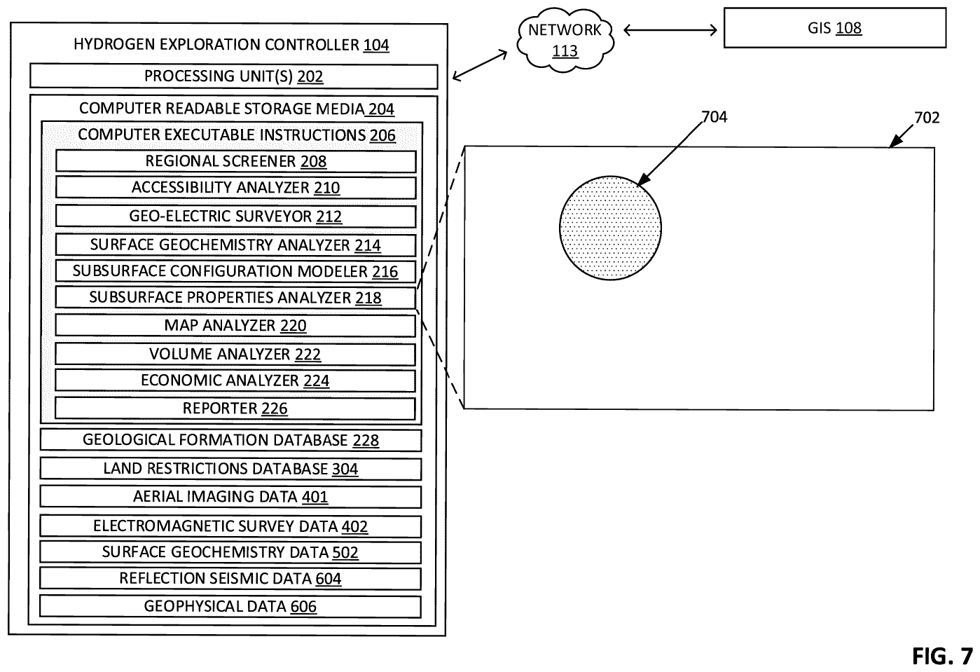

FIG. 7 illustrates a diagram of the non-limiting example hydrogen exploration controller 104 comprising the subsurface properties analyzer 218, which can be configured to detect areas in which the subsurface geological configuration of the region is conducive to natural hydrogen 118 accumulation based on the reflection seismic data 604, geophysical data 606, and/or fifth map 607 in accordance with one or more embodiments described herein. In one or more embodiments, the subsurface properties analyzer 218 can identify areas within the region having a subsurface geological configuration with a propensity for natural hydrogen 118 generation, migration, and/or accumulation based on the physical characteristics associated with one or more geological formulations (e.g., horizons and/or rock layers) characterized by the reflection seismic data 604, geophysical data 606, and/or fifth map 607.

For example, the subsurface properties analyzer 218 can determine one or more characteristics of the source rock 115, such as whether the source rock 115 is serpentinized peridotite or a radiogenic basement. Additionally, the subsurface properties analyzer 218 can determine one or more characteristics of the reservoir rock 116, such as the rock's porosity. Porosity of the reservoir rock 116 can affect the natural hydrogen's 118 ability to migrate and/or accumulate within the subsurface reservoir 102. For instance, natural hydrogen 118 is expected to migrate more freely through sandstone reservoirs, carbonate reservoirs, and/or crystalline rock with fracture porosity. Moreover, the subsurface properties analyzer 218 can determine one or more characteristics of the seal rock 117, such as the permeability of the rock. For instance, one or more samples of the seal rock 117 layer can be retrieved from one or more offset well in the region and analyzed to measure the its mercury injection capillary pressure, which can be included in the geophysical data 606. Due to the small size of the hydrogen molecule, it is expected that the seal capacity for hydrogen is less than that for natural gas or oil.

Additionally, the subsurface properties analyzer 218 can identify one or more faults 120 extending between the geological formations characterized by the reflection seismic data 604 as potential migration pathways for natural hydrogen 118 (e.g., as exemplified in FIG. 1). For example, the subsurface properties analyzer 218 can identify faults 120 extending from the determined presence of source rock 115 to reservoir rock 116 as a potential migration pathway for natural hydrogen 118. In some embodiments, the subsurface properties analyzer 218 can further determine whether the detected anticlinal traps 119 were present at the time of natural hydrogen 118 generation and migration.

In one or more embodiments, the subsurface properties analyzer 218 can detect areas with high propensity for natural hydrogen 118 generation, accumulation, and/or migration based on the identified characteristics of the source rock 115, reservoir rock 116, seal rock 117, and/or faults 120. For instance, areas comprising a serpentinized peridotite source rock 115 can have a higher propensity for natural hydrogen 118 generation. In another instance, areas comprising reservoir rock 116 with a porosity metric that is compliant with a defined porosity range (e.g., defined by one or more users via the one or more input devices 108) can have a higher propensity for natural hydrogen 118 migration. Additionally, areas comprising one or more faults 120 (e.g., extending from source rock 115 to reservoir rock 116) can also have a higher propensity for natural hydrogen 118 migration. In a further instance, areas comprising seal rock 117 with a permeability metric that is compliant with a defined permeability range (e.g., defined by one or more users via the one or more input devices 108) can have a higher propensity for natural hydrogen 118 accumulation. Further, areas comprising one or more anticlinal traps 119 can also have a higher propensity for natural hydrogen 118 accumulation.

In various embodiments, the subsurface properties analyzer 218 can estimate a hydrogen generation rate associated with the source rock 115. For example, the hydrogen generation rate can be based on one or more determined characteristics of the source rock 115 described herein (e.g., composition of the source rock 115, volume of the source rock 115, depth of the source rock 115, a combination thereof, and/or the like) and historic hydrogen generation data associated with geological formations of a similar nature. For instance, the one or more characteristics of the source rock 115 can be derived from or more determinations and/or features of the subsurface configuration modeler 216 described herein. Also, the historic hydrogen generation data can be included in the geophysical data 606. In one or more embodiments, the estimated hydrogen generation rate can be stochastically modelled (e.g., via a Monte Carlo model) to account for uncertainty and/or variance amongst the observational data and/or historic data upon which the hydrogen generation estimate is based. Further, the subsurface properties analyzer 218 can compute hydrogen generation associated with multiple scenarios, such as continuous hydrogen generation or episodic hydrogen generation.

In one or more embodiments, the subsurface properties analyzer 218 can estimate a hydrogen migration rate associated with the migration of hydrogen through the one or more faults 120 and/or reservoir rock 116. For example, the hydrogen migration rate can be a function of: the number of faults 120 in fluid communication with the source rock 115 (e.g., as estimated by the subsurface configuration modeler 216), the porosity of the reservoir rock 116, the thickness of the reservoir rock 116, the length of the one or more faults 120, an estimated volumetric capacity of the one or more faults 120, a combination thereof, and/or the like. In one or more embodiments, the estimated hydrogen migration rate can be stochastically modelled (e.g., via a Monte Carlo model) to account for uncertainty in the estimated geological subsurface characteristics upon which the hydrogen migration rate estimate is based.

In one or more embodiments, the subsurface properties analyzer 218 can also estimate a hydrogen accumulation rate (e.g., associated with the one or more anticlinal traps 119). For example, the hydrogen accumulation rate can be estimated based: on at least one or more subsurface geological characteristics determined by the subsurface configuration modeler 216, data from the geological formation database 228, and/or the geophysical data 606. For instance, the hydrogen accumulation rate can be based on the volumetric capacity of the reservoir rock 116 within the area and/or adjacent area of the one or more anticlinal traps 119 (e.g., which can be based on the cubic area of the anticlinal traps 119, the porosity of the reservoir rock 116, and/or the estimated water saturation of the reservoir rock 116). In accordance with one or more embodiments described herein, the hydrogen accumulation rate can be based on one or more determinations and/or calculations by the volume analyzer 222 described herein. Further, the estimated hydrogen accumulation rate can be stochastically modelled (e.g., via a Monte Carlo model) to account for uncertainty and/or variations in the estimated geological subsurface characteristics upon which the hydrogen accumulation rate estimate is based. For instance, Monte Carlo simulations can be performed to identify high, medium and low-risk accumulation scenarios.

In various embodiments, hydrogen can accumulate in the reservoir rock 116 outside of, or in the absence of, anticlinal traps 119 (e.g., absent a seal rock 117). For example, hydrogen can accumulate in the reservoir rock 116 where the estimated hydrogen generation rate markedly surpasses the hydrogen migration rate. For instance, where hydrogen cannot migrate through the reservoir rock 116 faster than it is introduced into the reservoir rock 116, a hydrogen accumulation can occur. The subsurface geological configuration may lack one or more faults 120; thereby, hydrogen migration may be more prominently dependent on the characteristics of the reservoir rock 116 (e.g., porosity and/or thickness), and as such may be substantially slower than the hydrogen generation rate of the source rock 115. In one or more embodiments, the subsurface properties analyzer 218 can estimate the hydrogen accumulation rate 218 in the absence of an anticlinal trap 119 based on, for example, the hydrogen generation rate and migration rate.

In one or more embodiments, the subsurface properties analyzer 218 can further estimate a hydrogen leakage rate (e.g., associated with the seal rock 117 and/or the reservoir rock 116). For example, the hydrogen leakage rate can be estimated based: on at least one or more subsurface geological characteristics determined by the subsurface configuration modeler 216, data from the geological formation database 228, and/or the geophysical data 606. For instance, the hydrogen leakage rate can be based on the porosity of the seal rock 117 and/or the reservoir rock 116, the thickness of the seal rock 117 and/or reservoir rock 116, the estimated water saturation of the reservoir rock 116, a combination thereof, and/or the like. Further, the estimated hydrogen leakage rate can be stochastically modelled (e.g., via a Monte Carlo model) to account for uncertainty and/or variations in the estimated geological subsurface characteristics upon which the hydrogen leakage rate estimate is based. For instance, with regards to a static hydrogen accumulation (e.g., via an anticlinal trap 119), the leakage rate can characterize the rate at which hydrogen escapes from the seal rock 117 to the surface. In another instance, with regards to an active hydrogen accumulation, the leakage rate can characterize the rate at which hydrogen escapes from the reservoir rock 116 to the surface (e.g., where the reservoir rock 116 serves to impede migration of the hydrogen from the subsurface accumulation despite a lack of seal rock 117).

In various embodiments, the subsurface properties analyzer 218 can compute a hydrogen propensity score as a function of the subsurface geological formation characteristics described herein (e.g., type of the source rock 115 in the area, porosity of the reservoir rock 116 in the area, location of faults 120 in the area, permeability of the seal rock 117 the area, and/or location of anticlinal traps 119 in the area), where the hydrogen propensity score can characterize the area's likelihood for generating natural hydrogen 118 that migrated to an anticlinal trap 119 for accumulation (e.g., static hydrogen accumulations) and/or the area's likelihood of having an active hydrogen accumulation (e.g., where an accumulation of hydrogen exists despite the presence of an anticlinal trap 119 due to the hydrogen accumulation rate exceeding the leakage rate). For example, the hydrogen propensity score can be a function (e.g., a summation) of: a value associated with the type of source rock 115, a value associated with the porosity of the reservoir rock 116, a value associated with the number and/or location of faults 120 potentially serving as migration pathways, a value associated with the permeability of the seal rock 117, and/or a value associated with the number and/or location of detected anticlinal traps 119 in the area. In one or more embodiments, the hydrogen propensity score can be a function of the estimated hydrogen generation rate, migration rate, accumulation rate, and/or leakage rate. Further, the respective values of the hydrogen propensity score function can be weighted based on one or more user preferences to reflect the associated geological characteristic's contribution to the likelihood of subsurface hydrogen.

As shown in FIG. 7, the subsurface properties analyzer 218 can generate a sixth map 702 of the region of interest. In one or more embodiments, the subsurface properties analyzer 218 can identify areas associated with a hydrogen propensity score of at least a defined value as inputs to the GIS 108 to generate the sixth map 702. Additionally, the sixth map 702 can delineate the location of areas within the region that have a computed hydrogen propensity score exceeding a predefined threshold (e.g., defined by one or more users via the one or more input devices 108), based on the reflection seismic data 604 and/or geophysical data 606. For instance, the example sixth map 702 shown in FIG. 7 include a shaded area 704 delineating the location of one or more areas predicted to have a high propensity for natural hydrogen 118 generation, migration, and/or accumulation.

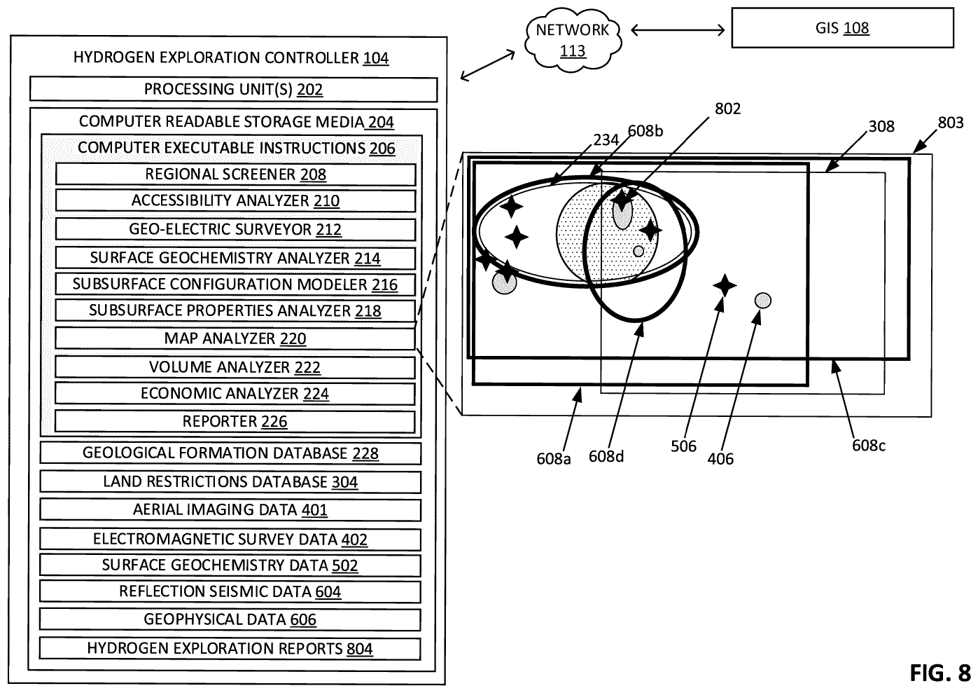

FIG. 8 illustrates a diagram of the non-limiting example hydrogen exploration controller 104 comprising the map analyzer 220, which can be configured to identify one or more exploration areas 802 of interest based on the maps generated by the hydrogen exploration controller 104 in accordance with one or more embodiments described herein. In one or more embodiments, the map analyzer 220 can be configured to generate (e.g., in conjunction with the GIS 108) a seventh map 803 by overlaying the first map 232, second map 306, third map 404, fourth map 504, fifth map 607, and/or sixth map 702 over each other to identify one or more areas commonly delineated by the respective maps.

For instance, the hydrogen exploration controller 104 can identify an exploration area 802 of interest based on the given area being accessible (e.g., as delineated by the second map 306) and/or comprising: ophiolites, aulacogens, and/or cratons (e.g., as delineated by the first map 232); subsurface anomalies in the electromagnetic survey data 402 associated with the presence of natural hydrogen 118 (e.g., as delineated by the third map 404); hydrogen seepages 124 at the surface 114 (e.g., as delineated by the fourth map 504); a subsurface geological configuration that can accommodate natural hydrogen 118 generation, migration, and/or accumulation (e.g., as delineated by the fifth map 607); and/or subsurface geological properties associated with a propensity for natural hydrogen 118 generation, migration, and/or accumulation (e.g., as delineated by the sixth map 702). In some examples, the exploration area 802 of interest can be an area of the region commonly delineated by each of the respective maps. In other examples, the exploration area 802 of interest can be an area of the region delineated by two or more of the respective maps.

In some embodiments, the hydrogen exploration controller 104 can assign each map a respective interest score value based on a hierarchy of the maps in relation to determining the exploration area 802. Further, the hydrogen exploration controller 104 can determine an exploration score for each area of the region as a function (e.g., a summation) of the interest score values associated with maps that delineate the given area as an area of interest (e.g., as being accessible for exploration and/or comprising one or more of the geological features described herein). For example, the features upon which one map was generated may be afforded more relevance to the identification of the exploration area 802 than the features upon which another map was generated. For instance, a user of the system 100 may prioritize the accessibility of an area above the detected occurrences of hydrogen seepages 124 in that area. In such case, the hydrogen exploration controller 104 can weigh the second map 306 with a higher interest score value than the interest score value for the fourth map 504. Additionally, the hydrogen exploration controller 104 can identify exploration areas 802 as those areas within the region having an exploration score that exceeds a pre-defined exploration threshold. Thereby, the exploration areas 802 can be identified as areas in the region having the greatest convergence of prioritized geological and/or accessibility features associated with the generation, migration, and/or accumulation of natural hydrogen 118.

In one or more embodiments, the volume analyzer 222 can estimate the amount of natural hydrogen 118 that may be comprised within the one or more exploration areas 802 of interest. For example, the volume analyzer 222 can estimate the volume of natural hydrogen 118 that may be accumulated within one or more anticlinal traps 119. The size of the hydrogen deposit can be estimated by the volume analyzer 222 based on the porosity of the reservoir rock 116, the geometry of the reservoir rock 116 (e.g., the area and/or thickness of the reservoir rock 116), and/or water saturation of the reservoir rock 116. In various embodiments, the porosity and water saturation can be defined in the geophysical data 606 and can be derived from, for example, offset wells within the region and/or analogous rock formations. Additionally, the geometry of the reservoir rock 116 can be based on the reflection seismic data 604.

In some embodiments, the volume analyzer 222 can estimate the size of the hydrogen deposit deterministically or by a Monte Carlo simulation. For example, the volume analyzer 222 can determine the size of the hydrogen deposit in accordance with Equation 1 below.

$${H}_{2} Deposit Size = {Ahm}_{p} ( 1 {m}_{s w} ) - Ah {ρ}_{sw} {σ}_{p} {σ}_{sw} \qquad ( 1 )$$

Where “A” can represent the area of the reservoir rock 116, “h” represents the thickness of the reservoir rock 116 “mₚ” represents the mean porosity of the reservoir rock 116, “m_{sw}” represents the mean water saturation of the reservoir rock 116, “P_{sw}” represents the Pearson-correlation coefficient between porosity and water saturation, “σₚ” represents the standard deviation of the porosity, and “σ_{sw}” represents the standard deviation of the water saturation.

In one or more embodiments, the volume analyzer 222 can further incorporate a net-to-gross ratio variable to remove ineffective pore space and non-producible hydrogen. Also, in some embodiments the volume analyzer 222 can consider the amount of natural hydrogen 118 that may have escaped through the seal rock 117 over time (e.g., based on the permeability measurements of the seal rock 117). Further, in some embodiments the volume analyzer 222 can consider the rate of hydrogen accumulation in the one or more one or more anticlinal traps 119. In some embodiments, as described herein, the volume analyzer 222 can estimate the volume of a hydrogen deposit where there is a lack of anticlinal traps 119 and the trapped hydrogen is a function of the hydrogen generation rate being greater than the hydrogen leakage rate. In various embodiments, the volume analyzer 222 can further determine one or more gas flux rates associated with the subsurface accumulation.

In one or more embodiments, the economic analyzer 224 can perform an economic analysis to determine whether a drilling campaign in the one or more exploration areas 802 can be profitable. The economic analysis can be based on established petroleum economics, with hydrocarbon-specific inputs replaced with hydrogen-specific inputs. For example, the economic analysis performed by the economic analyzer 224 can estimate the amount of revenue that can be obtained from the one or more exploration areas 802 based on the volume determinations by the volume analyzer 222, market prices for hydrogen gas, current supply and/or demand for hydrogen gas, a combination thereof, and/or the like. Additionally, the economic analyzer 224 can account for various expenses in retrieving the natural hydrogen 118 from the exploration areas 802 and bring the natural hydrogen 118 to market. For example, such expenses can include, but are not limited to: the cost of the drilling campaign (e.g., equipment costs, operating costs, labor costs, costs associated with regulatory compliance), transportation costs, maintenance costs, infrastructure costs (e.g., building roads, storage facilities, and other structures to support the drilling campaign), a combination thereof, and/or the like.

In one or more embodiment, the reporter 226 can generate one or more hydrogen exploration reports 804 summarizing the hydrogen exploration analysis conducted by the various computer executable instructions 206. For example, the one or more hydrogen exploration reports 804 can include: the generated maps of the region (e.g., the first map 232, the second map 306, the third map 404, the fourth map 504, the fifth map 607, the sixth map 702, and/or the seventh map 803), the identified exploration areas 802, the aerial imaging data 401, the electromagnetic survey data 402, the surface geochemistry data 502, the reflection seismic data 604, the geophysical data 606, the volume estimations, and/or the economic analysis.

In various embodiments, the one or more hydrogen exploration reports 804 can be utilized to guide one or more exploratory drilling campaigns. For example, one or more exploration wells can be drilled in those exploration areas 802 determined to have potential profitability, where well logging and sampling can be performed to determine hydrogen reservoir parameters. The exploratory drilling can utilize techniques developed in petroleum, geothermal, and/or water exploration. Additionally, in one or more embodiments data (e.g., well logs and/or soil samples) collected from the exploratory drilling can be supplied to the hydrogen exploration controller 104 (e.g., as geophysical data 606) to update the determinations made by the subsurface configuration modeler 216, subsurface properties analyzer 218, map analyzer 220, volume analyzer 222, and/or economic analyzer 224.

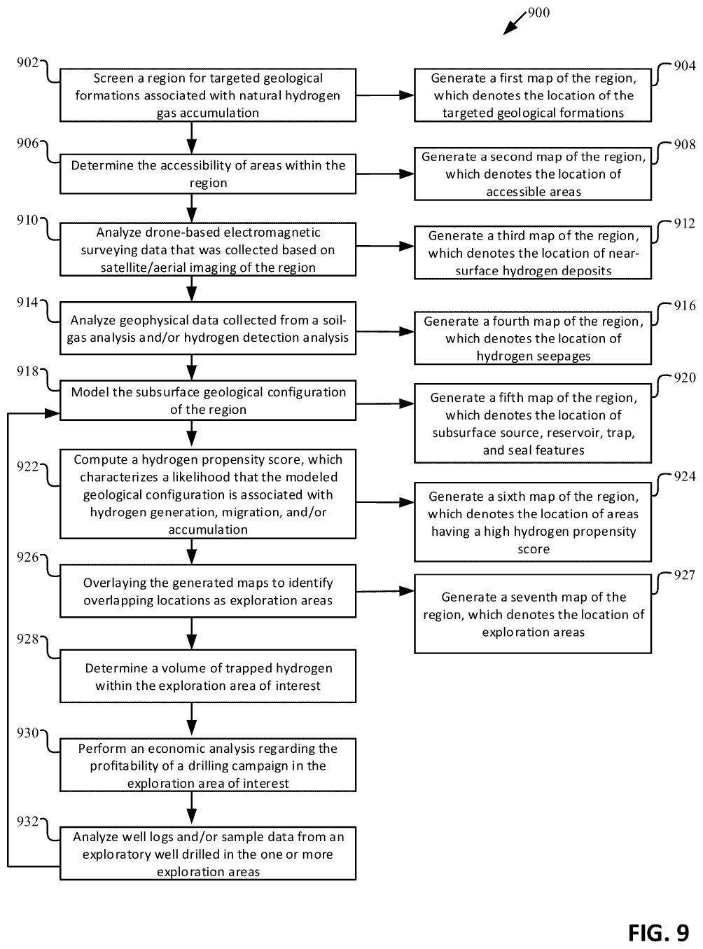

In view of the foregoing structural and functional features described above, example methods will be better appreciated with reference to FIG. 9. While, for purposes of simplicity of explanation, the example methods of FIG. 9 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 9 illustrates a flow diagram of a non-limiting example method 900 that can be implemented to predict the location of one or more subsurface reservoirs 102 of natural hydrogen in accordance with one or more embodiments described herein. In one or more embodiments, the method 900, or respective features thereof, can be implemented by system 100. In accordance with various embodiments described herein, one or more features of method 900 can be employed (e.g. by one or more computer executable instructions 206) to derive one or more inputs to a GIS 108 to generate one or more maps described herein.

At 902, the method 900 can comprise screening (e.g., via regional screener 208) a region for targeted geological formations associated with natural hydrogen 118 gas accumulation (e.g., by a system 100 operably coupled to the one or more processing units 202). For example, in accordance with one or more embodiments described herein, the screening can comprising screening (e.g., via the regional screener 208) the geographical region for known ophiolites, aulacogens, and/or cratons based on geological formation data provided by one or more GISs 108 and/or stored in a geological formation database 228. At 904, the method 900 can comprise generating (e.g., via regional screener 208 and/or the GIS 108) a first map of the region that denotes the location of the targeted geological formation (e.g., as exemplified by the first map 232).

At 906, the method 900 can comprise determining (e.g., via accessibility analyzer 210) the accessibility of one or more areas with the region with regards to drilling campaigns and/or land use. For example, in accordance with one or more embodiments described herein, the method 900 can comprise ascertaining (e.g., via the accessibility analyzer 210) the accessibility of the one or more areas for hydrogen drilling operations based on one or more land use regulations defined in the land restrictions database 304 in accordance with one or more embodiments described herein. At 908, the method 900 can comprise generating (e.g., via accessibility analyzer 210 and/or GIS 108) a second map of the region that denotes the location of accessible areas within the region for exploratory drilling campaigns (e.g., as exemplified by the second map 306).

At 910, the method 900 can comprise analyzing (e.g., via geo-electric surveyor 212) drone-based electromagnetic surveying data that was collected based on satellite and/or aerial imaging of the region. For example, in accordance with one or more embodiments described herein, the method 900 can comprise can coordinating and/or controlling (e.g., via geo-electric surveyor 212) an electromagnetic survey conducted via one or more aerial drones 106 flying flight paths that over one or more fairy circles 122 identified from the satellite and/or aerial imaging. At 912, the method 900 can comprise generating (e.g., via the geo-electric surveyor 212 and/or GIS 108) a third map of the region that denotes the location of near surface hydrogen deposits based on one or more anomalies detected by the electromagnetic survey (e.g., as exemplified by the third map 404).

At 914, the method 900 can comprise analyzing (e.g., via surface geochemistry analyzer 214) geophysical data collected from a soil-gas analysis and/or hydrogen detection analysis. For example, in accordance with one or more embodiments described herein, the method 900 can comprise coordinating and/or controlling (e.g., via geochemistry analyzer 214) operation of one or more hydrogen detection devices 111 near the one or more detected fairy circles 122 to detect surface level hydrogen seepages 124. At 916 the method 900 can comprise generating (e.g., via the surface geochemistry analyzer 214 and/or GIS 108) a fourth map of the region that denotes the location of one or more hydrogen seepages 124 in the region (e.g., as exemplified by the fourth map 504).

At 918, the method 900 can comprise modeling (e.g., via the subsurface configuration modeler 216) the subsurface geological configuration of the area. For example, in accordance with one or more embodiments described herein, the method 900 can comprise analyzing (e.g., via the subsurface configuration modeler 216) reflection seismic data 604 to determine the location and/or geometry of subsurface geological formations. Additionally, the subsurface configuration modeler 216 can analyze geophysical data 606 harvested from offset wells and/or outcrops in the region to correlate the detected subsurface geological formations to the presence of source rock 115, reservoir rock 116, seal rock 117, and/or anticlinal traps 119 in accordance with one or more embodiments described herein. At 920, the method 900 can comprise generating (e.g., via the subsurface configuration modeler 216 and/or GIS 108) a fifth map of the region that denotes the predicted location of the subsurface source rock 115, reservoir rock 116, seal rock 117, and/or anticlinal traps 119 (e.g., as exemplified by the fifth map 607).

At 922, the method 900 can comprise computing (e.g., via the subsurface properties analyzer 218) a hydrogen propensity score for one or more areas within the region, where the hydrogen propensity score can characterize a likelihood that the modeled geological configuration at 918 is associated with natural hydrogen generation, migration, and/or accumulation. For example, in accordance with one or more embodiments described herein, the method 900 can comprise determining (e.g., via the subsurface properties analyzer 218) the hydrogen propensity score as a function of geophysical characteristics of the source rock 115, reservoir rock 116, and/or seal rock 117 along with the number and/or location of anticlinal traps 119 and/or faults 120 in the area in accordance with one or more embodiments described herein. In one or more embodiments, the subsurface properties analyzer 218 can further consider the age of the anticlinal traps 119 in relation to the source rock 115 when computing the hydrogen propensity score (e.g., to ascertain whether the anticlinal traps 119 existed at the same time as natural hydrogen generation by the source rock 115). In various embodiments, the method 900 can comprise determining the hydrogen propensity based on an estimate hydrogen generation rate, estimated hydrogen migration rate, estimated hydrogen accumulation rate, and/or estimated hydrogen leakage rate as described herein. At 924, the method 900 can comprise generating (e.g., via the subsurface properties analyzer 218 and/or GIS 108) a sixth map (e.g., as exemplified by the sixth map 702) of the region that denotes the location of areas having a high hydrogen propensity score (e.g., a computed hydrogen propensity score that exceeds one or more predefined thresholds).

At 926, the method 900 can comprise overlaying (e.g., via the map analyzer 220) the generated maps to identify overlapping denoted locations as exploration areas 802 for potential exploratory drilling campaigns. For example, in accordance with one or more embodiments described herein, the method 900 can comprise identifying (e.g., the map analyzer 220) areas where two or more locations commonly denoted in the maps generated at 904, 908, 912, 916, 920, and/or 924 as exploration areas. For instance, each of the maps generated at 904, 908, 912, 916, 920, and/or 924 can denote areas of respective geological features within the region associated with the presence of a subsurface reservoir 102 of natural hydrogen, where the exploration areas 802 can denote a convergence of two or more of the respective geological features denoted by the maps in accordance with one or more embodiments described herein. At 927, the method 900 can comprise generating (e.g., via the map analyzer 220 and/or GIS 108) a seventh map that denotes the location of the exploration area 802 (e.g., as exemplified by seventh map 803).

At 928, the method 900 can comprise determining (e.g., via the volume analyzer 222) the volume of trapped natural hydrogen within the exploration areas 802 identified at 926. For example, in accordance with one or more embodiments described herein, the method 900 can comprise determining (e.g., via the volume analyzer 222) the volume based on Equation 1 in accordance with one or more embodiments described herein. At 930, the method 900 can comprise performing (e.g., via the economic analyzer 224) an economic analysis regarding the potential profitability of a drilling campaign in the one or more exploration areas 802 to retrieve natural hydrogen 118 from a subsurface reservoir 102. In various embodiments, one or more exploratory drilling campaigns can be launched in the exploration areas 802 that are determined to be potentially profitable by the economic analysis. At 932, the method 900 can comprise analyzing (e.g., via the subsurface configuration modeler 216 and/or the subsurface properties analyzer 218) well logs and/or sample data from an exploratory well drilled in the one or more exploration areas to update and/or verify the subsurface geological configuration and/or property determinations made at 918 and/or 922. For example, FIG. 9 illustrates an example embodiment in which the method 900 proceeds back to 918 to repeat features 918-930 based further on the well logs and/or sample data to validate and/or constrain one or more previous determinations of the method 900 (e.g., to augment one or more of the maps generated at 920, 924, and/or 927 based on the well logs and/or sample data from the exploratory well).

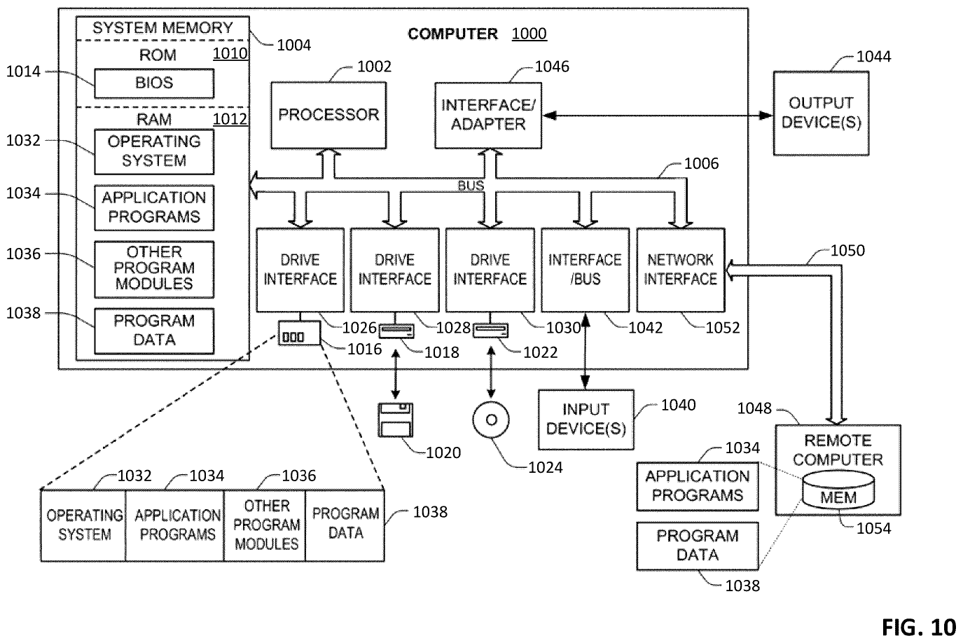

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 10. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 10 illustrates one example of a computer system 1000 that can be employed to execute one or more embodiments of the present disclosure. Computer system 1000 can be implemented on one or more general purpose networked computer systems, embedded computer systems, routers, switches, server devices, client devices, various intermediate devices/nodes or standalone computer systems. Additionally, computer system 1000 can be implemented on various mobile clients such as, for example, a personal digital assistant (PDA), laptop computer, pager, and the like, provided it includes sufficient processing capabilities.

Computer system 1000 includes processing unit 1002, system memory 1004, and system bus 1006 that couples various system components, including the system memory 1004, to processing unit 1002. Dual microprocessors and other multi-processor architectures also can be used as processing unit 1002. System bus 1006 may be any of several types of bus structure including a memory bus or memory controller, a peripheral bus, and a local bus using any of a variety of bus architectures. System memory 1004 includes read only memory (ROM) 1010 and random access memory (RAM) 1012. A basic input/output system (BIOS) 1014 can reside in ROM 1010 containing the basic routines that help to transfer information among elements within computer system 1000.

Computer system 1000 can include a hard disk drive 1016, magnetic disk drive 1018, e.g., to read from or write to removable disk 1020, and an optical disk drive 1022, e.g., for reading CD-ROM disk 1024 or to read from or write to other optical media. Hard disk drive 1016, magnetic disk drive 1018, and optical disk drive 1022 are connected to system bus 1006 by a hard disk drive interface 1026, a magnetic disk drive interface 1028, and an optical drive interface 1030, respectively. The drives and associated computer-readable media provide nonvolatile storage of data, data structures, and computer-executable instructions for computer system 1000. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 1010, including operating system 1032, one or more application programs 1034, other program modules 1036, and program data 1038. In some examples, the application programs 1034 can include regional screener 208, accessibility analyzer 210, geo-electric surveyor 212, surface geochemistry analyzer 214, subsurface configuration modeler 216, subsurface properties analyzer 218, map analyzer 220, volume analyzer 222, economic analyzer 224, reporter 226, and/or GIS 108, and the program data 1038 can include geological formation database 228, land restrictions database 304, aerial imaging data 401, electromagnetic survey data 402, surface geochemistry data 502, reflection seismic data 604, geophysical data 606, hydrogen exploration reports 804, one or more predefined threshold values, and/or a geological feature hierarchy described herein. The application programs 1034 and program data 1038 can include functions and methods programmed to identify exploration areas 802 that are predicted to comprise a subsurface reservoir 102 of natural hydrogen 118, such as shown and described herein.

A user may enter commands and information into computer system 1000 through one or more input devices 1040, such as a pointing device (e.g., a mouse, touch screen), keyboard, microphone, joystick, game pad, scanner, and the like. For instance, the user can employ input device 1040 to edit or modify the geological formation database 228, the land restrictions database 304, the surface geochemistry data 502, the geophysical data 604, and/or the one or more predefined threshold values (e.g., the predefined target porosity range for reservoir rock 116, the predefined target permeability range for seal rock 117, and/or the hydrogen propensity score threshold), and/or the geological feature hierarchy preference described herein. These and other input devices 1040 are often connected to processing unit 1002 through a corresponding port interface 1042 that is coupled to the system bus, but may be connected by other interfaces, such as a parallel port, serial port, or universal serial bus (USB). One or more output devices 1044 (e.g., display, a monitor, printer, projector, or other type of displaying device) is also connected to system bus 1006 via interface 1046, such as a video adapter.

Computer system 1000 may operate in a networked environment using logical connections to one or more remote computers, such as remote computer 1048. Remote computer 1048 may be a workstation, computer system, router, peer device, or other common network node, and typically includes many or all the elements described relative to computer system 1000. The logical connections, schematically indicated at 1050, can include a local area network (LAN) and a wide area network (WAN). When used in a LAN networking environment, computer system 1000 can be connected to the local network through a network interface or adapter 1052. When used in a WAN networking environment, computer system 1000 can include a modem, or can be connected to a communications server on the LAN. The modem, which may be internal or external, can be connected to system bus 1006 via an appropriate port interface. In a networked environment, application programs 1034 or program data 1038 depicted relative to computer system 1000, or portions thereof, may be stored in a remote memory storage device 1054.

### Additional Embodiments

The present disclosure is also directed to the following exemplary embodiments, which can be practiced in any combination thereof:

Embodiment 1: A system, comprising: memory to store computer executable instructions; and one or more processors, operatively coupled to the memory, that execute the computer executable instructions to implement: a hydrogen exploration controller configured to generate a plurality of maps characterizing a geographical region, wherein respective maps from the plurality of maps delineate a location of respective geological features within the geographical region that are associated with a presence of a subsurface reservoir of natural hydrogen, and wherein the hydrogen exploration controller is further configured to identify an area in the geographical region that comprises a convergence of two or more of the respective geological features based on the plurality of maps

Embodiment 2: The system of embodiment 1, wherein the hydrogen exploration controller comprises: a regional screener configured to generate a map from the plurality of maps that delineates a location of an ophiolite, aulacogen, craton, or combination thereof based on geological formation data provided by a geographic information system.

Embodiment 3: The system of embodiment 1 or 2, wherein the hydrogen exploration controller comprises: an accessibility analyzer configured to generate a map from the plurality of maps that delineates a location of an area that is accessible to hydrogen drilling operations based on a land use regulation governing the geographical region.

Embodiment 4: The system of any of embodiments 1-3, wherein the hydrogen exploration controller comprises: a geo-electric surveyor configured to generate a map from the plurality of maps that delineates a location of an area predicted to comprise subsurface natural hydrogen based on an electromagnetic survey conducted in the geographical region.

Embodiment 5: The system of any of embodiments 1-4, wherein the hydrogen exploration controller comprises: a surface geochemistry analyzer configured to generate a map from the plurality of maps that delineates a location of a surface level hydrogen seepage based on geophysical data collected from a hydrogen detection device positioned within the geographical region.

Embodiment 6: The system of any of embodiments 1-5, wherein the hydrogen exploration controller comprises: a subsurface configuration modeler configured to generate a map from the plurality of maps that delineates a location of natural hydrogen source rock, reservoir rock, seal rock, or a combination thereof based on a reflection seismology survey conducted in the geographical region.

Embodiment 7: The system of any of embodiments 1-6, wherein the hydrogen exploration controller further comprises: a subsurface properties analyzer configured to generate another map from the plurality of maps that delineates a location of an area having a hydrogen propensity score indicative that the area has a likelihood of natural hydrogen generation, migration, accumulation, or a combination thereof that is greater than a predefined threshold, wherein the subsurface properties analyzer is further configured to compute the hydrogen propensity score based on geophysical data characterizing the natural hydrogen source rock, reservoir rock, seal rock, or a combination thereof.

Embodiment 8: A method, comprising: generating a plurality of maps characterizing a geographical region, wherein respective maps from the plurality of maps delineate a location of respective geological features within the geographical region that are associated with a presence of a subsurface reservoir of natural hydrogen; and identifying an area in the geographical region that comprises a convergence of two or more of the respective geological features based on the plurality of maps.

Embodiment 9: The method of embodiment 8, further comprising: generating a first map from the plurality of maps that delineates a location of an ophiolite, aulacogen, craton, or combination thereof based on geological formation data provided by a geographic information system.

Embodiment 10: The method of embodiment 8 or 9, further comprising: generating a second map from the plurality of maps that delineates a location of an area that is accessible to hydrogen drilling operations based on a land use regulation governing the geographical region.

Embodiment 11: The method of any of embodiments 8-10, further comprising: generating a third map from the plurality of maps that delineates a location of an area predicted to comprise subsurface natural hydrogen based on an electromagnetic survey conducted in the geographical region.

Embodiment 12: The method of any of embodiments 8-11, further comprising: generating a fourth map from the plurality of maps that delineates a location of a surface level hydrogen seepage based on geophysical data collected from a hydrogen detection device positioned within the geographical region.

Embodiment 13: The method of any of embodiments 8-12, further comprising: generating a fifth map from the plurality of maps that delineates a location of natural hydrogen source rock, reservoir rock, seal rock, or a combination thereof based on a reflection seismology survey conducted in the geographical region.

Embodiment 14: The method of any of embodiments 8-13, computing a hydrogen propensity score for an area within the geographical region, wherein the hydrogen propensity score characterizes a likelihood of subsurface natural hydrogen generation, migration, accumulation, or a combination thereof; and generating a sixth map from the plurality of maps that delineates a location of the area based on the hydrogen propensity score being greater than a predefined threshold.

Embodiment 15: A computer program product for predicting a location of a subsurface reservoir of natural hydrogen, the computer program product comprising a computer readable storage medium having computer executable instructions embodied therewith, the computer executable instructions executable by one or more processors to cause the one or more processors to: generate a plurality of maps characterizing a geographical region, wherein respective maps from the plurality of maps delineate a location of respective geological features within the geographical region that are associated with a presence of the subsurface reservoir of natural hydrogen; and identify an area in the geographical region that comprises a convergence of two or more of the respective geological features based on the plurality of maps.

Embodiment 16: The computer program product of embodiment 15, wherein the computer executable instructions further cause the one or more processors to: generate a first map from the plurality of maps that delineates a location of an ophiolite, aulacogen, craton, or combination thereof based on geological formation data provided by a geographic information system.

Embodiment 17: The computer program product of embodiment 15 or 16, wherein the computer executable instructions further cause the one or more processors to: generating a second map from the plurality of maps that delineates a location of an area that is accessible to hydrogen drilling operations based on a land use regulation governing the geographical region.

Embodiment 18: The computer program product of embodiment 15, wherein the computer executable instructions further cause the one or more processors to: generate a first map from the plurality of maps that delineates a location of an area predicted to comprise subsurface natural hydrogen based on an electromagnetic survey conducted in the geographical region.

Embodiment 19: The computer program product of embodiment 15 or 18, wherein the computer executable instructions further cause the one or more processors to: generate a second map from the plurality of maps that delineates a location of a surface level hydrogen seepage based on geophysical data collected from a hydrogen detection device positioned within the geographical region.

Embodiment 20: The computer program product of embodiment 15, wherein the computer executable instructions further cause the one or more processors to: generate a first map from the plurality of maps that delineates a location of natural hydrogen source rock, reservoir rock, seal rock, or a combination thereof based on a reflection seismology survey conducted in the geographical region; compute a hydrogen propensity score for an area within the geographical region, wherein the hydrogen propensity score characterizes a likelihood of subsurface natural hydrogen generation, migration, accumulation, or a combination thereof; and generate a second map from the plurality of maps that delineates a location of the area based on the hydrogen propensity score being greater than a predefined threshold.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system, comprising:
memory to store computer executable instructions; and
one or more processors, operatively coupled to the memory, that execute the computer executable instructions to implement:
a hydrogen exploration controller configured to generate a plurality of maps characterizing a geographical region, wherein respective maps from the plurality of maps delineate a location of respective geological features within the geographical region that are associated with a presence of a subsurface reservoir of natural hydrogen, and wherein the hydrogen exploration controller is further configured to identify an area in the geographical region that comprises a convergence of two or more of the respective geological features based on the plurality of maps.

2. The system of claim 1, wherein the hydrogen exploration controller comprises:
a regional screener configured to generate a map from the plurality of maps that delineates a location of an ophiolite, aulacogen, craton, or combination thereof based on geological formation data provided by a geographic information system.

3. The system of claim 1, wherein the hydrogen exploration controller comprises:
an accessibility analyzer configured to generate a map from the plurality of maps that delineates a location of an area that is accessible to hydrogen drilling operations based on a land use regulation governing the geographical region.

4. The system of claim 1, wherein the hydrogen exploration controller comprises:
a geo-electric surveyor configured to generate a map from the plurality of maps that delineates a location of an area predicted to comprise subsurface natural hydrogen based on an electromagnetic survey conducted in the geographical region.

5. The system of claim 1, wherein the hydrogen exploration controller comprises:
a surface geochemistry analyzer configured to generate a map from the plurality of maps that delineates a location of a surface level hydrogen seepage based on geophysical data collected from a hydrogen detection device positioned within the geographical region.

6. The system of claim 1, wherein the hydrogen exploration controller comprises:
a subsurface configuration modeler configured to generate a map from the plurality of maps that delineates a location of natural hydrogen source rock, reservoir rock, seal rock, or a combination thereof based on a reflection seismology survey conducted in the geographical region.

7. The system of claim 6, wherein the hydrogen exploration controller further comprises:
a subsurface properties analyzer configured to generate another map from the plurality of maps that delineates a location of an area having a hydrogen propensity score indicative that the area has a likelihood of natural hydrogen generation, migration, accumulation, or a combination thereof that is greater than a predefined threshold, wherein the subsurface properties analyzer is further configured to compute the hydrogen propensity score based on geophysical data characterizing the natural hydrogen source rock, reservoir rock, seal rock, or a combination thereof.

8. A method, comprising:
generating a plurality of maps characterizing a geographical region, wherein respective maps from the plurality of maps delineate a location of respective geological features within the geographical region that are associated with a presence of a subsurface reservoir of natural hydrogen; and
identifying an area in the geographical region that comprises a convergence of two or more of the respective geological features based on the plurality of maps.

9. The method of claim 8, further comprising:
generating a first map from the plurality of maps that delineates a location of an ophiolite, aulacogen, craton, or combination thereof based on geological formation data provided by a geographic information system.

10. The method of claim 9, further comprising:
generating a second map from the plurality of maps that delineates a location of an area that is accessible to hydrogen drilling operations based on a land use regulation governing the geographical region.

11. The method of claim 10, further comprising:
generating a third map from the plurality of maps that delineates a location of an area predicted to comprise subsurface natural hydrogen based on an electromagnetic survey conducted in the geographical region.

12. The method of claim 11, further comprising:
generating a fourth map from the plurality of maps that delineates a location of a surface level hydrogen seepage based on geophysical data collected from a hydrogen detection device positioned within the geographical region.

13. The method of claim 12, further comprising:
generating a fifth map from the plurality of maps that delineates a location of natural hydrogen source rock, reservoir rock, seal rock, or a combination thereof based on a reflection seismology survey conducted in the geographical region.

14. The method of claim 13, further comprising:
computing a hydrogen propensity score for an area within the geographical region, wherein the hydrogen propensity score characterizes a likelihood of subsurface natural hydrogen generation, migration, accumulation, or a combination thereof; and
generating a sixth map from the plurality of maps that delineates a location of the area based on the hydrogen propensity score being greater than a predefined threshold.

15. A computer program product for predicting a location of a subsurface reservoir of natural hydrogen, the computer program product comprising a computer readable storage medium having computer executable instructions embodied therewith, the computer executable instructions executable by one or more processors to cause the one or more processors to:
generate a plurality of maps characterizing a geographical region, wherein respective maps from the plurality of maps delineate a location of respective geological features within the geographical region that are associated with a presence of the subsurface reservoir of natural hydrogen; and
identify an area in the geographical region that comprises a convergence of two or more of the respective geological features based on the plurality of maps.

16. The computer program product of claim 15, wherein the computer executable instructions further cause the one or more processors to:
generate a first map from the plurality of maps that delineates a location of an ophiolite, aulacogen, craton, or combination thereof based on geological formation data provided by a geographic information system.

17. The computer program product of claim 16, wherein the computer executable instructions further cause the one or more processors to:
generating a second map from the plurality of maps that delineates a location of an area that is accessible to hydrogen drilling operations based on a land use regulation governing the geographical region.

18. The computer program product of claim 15, wherein the computer executable instructions further cause the one or more processors to:
generate a first map from the plurality of maps that delineates a location of an area predicted to comprise subsurface natural hydrogen based on an electromagnetic survey conducted in the geographical region.

19. The computer program product of claim 15, wherein the computer executable instructions further cause the one or more processors to:
generate a second map from the plurality of maps that delineates a location of a surface level hydrogen seepage based on geophysical data collected from a hydrogen detection device positioned within the geographical region.

20. The computer program product of claim 15, wherein the computer executable instructions further cause the one or more processors to:
generate a first map from the plurality of maps that delineates a location of natural hydrogen source rock, reservoir rock, seal rock, or a combination thereof based on a reflection seismology survey conducted in the geographical region;
compute a hydrogen propensity score for an area within the geographical region, wherein the hydrogen propensity score characterizes a likelihood of subsurface natural hydrogen generation, migration, accumulation, or a combination thereof; and
generate a second map from the plurality of maps that delineates a location of the area based on the hydrogen propensity score being greater than a predefined threshold.
